(19) United States
(12) Patent Application Publication
(10) Pub. No.: US 2018/0017180 A1
(43) Pub. Date: Jan. 18, 2018

(54) WATERPROOF VALVE AND ELCTRONIC DEVICE USING THE SAME

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: FU-KUO HUANG, New Taipei (TW)

(21) Appl. No.: 15/246,560

(22) Filed: Aug. 25, 2016

(30) Foreign Application Priority Data
Jul. 18, 2016 (CN) 201610565619.6

(51) Int. Cl. F16K 31/22; F16K 1/16; F16K 1/34; F16K 33/00

(52) U.S. Cl. CPC F16K 31/22; F16K 33/00; F16K 1/16; F16K 1/34

(57) ABSTRACT

A waterproof valve includes a pivot, a valve comprising a sealing end and a floating end, the pivot is rotatably connected with the valve between the sealing end and the floating end, the sealing end is released to keep the valve open when the floating end is not contact with fluids, the sealing end is driven by the floating end to close the valve when the floating end is contact with fluids, to prevent or reduce the occurrence of short circuits caused by exposure to conductive fluids.

### FIELD

The subject matter herein generally relates to a waterproof valve and an electronic device using the waterproof valve.

### BACKGROUND

To meet specific function needs, some products, such as acoustic components, are needed to set openings to transmit sounds or airflow. At the same time, the openings on such products should be waterproof to ensure electrical safety. Therefore, providing a waterproof structure to prevent or reduce the occurrence of short circuits caused by exposure to conductive fluids would be beneficial.

### BRIEF DESCRIPTION OF THE DRAWINGS

Implementations of the present technology will now be described, by way of example only, with reference to the attached figures.

FIG. 1 is a sectional view of an embodiment of a waterproof valve in a first state.

FIG. 2 is similar to the FIG. 1, but showing the waterproof valve in a second state.

FIG. 3 is a sectional view of another embodiment of a waterproof valve in a first state.

FIG. 4 is similar to the FIG. 3, but showing the waterproof valve in a second state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

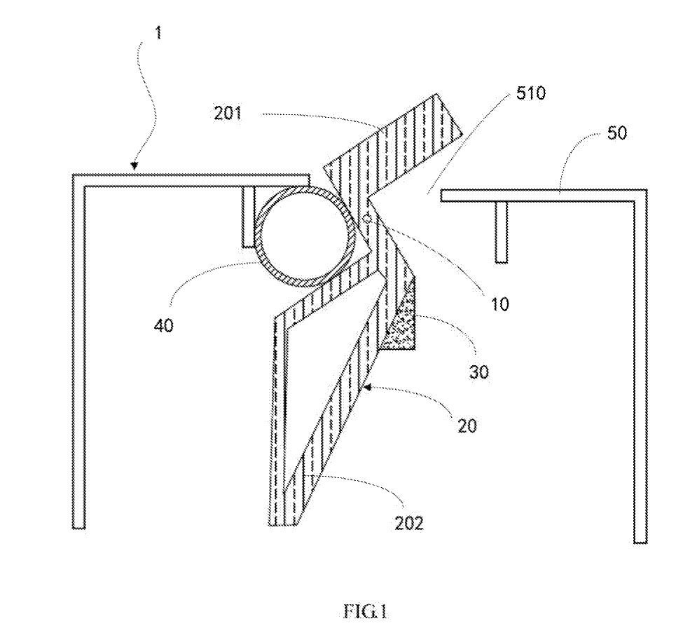

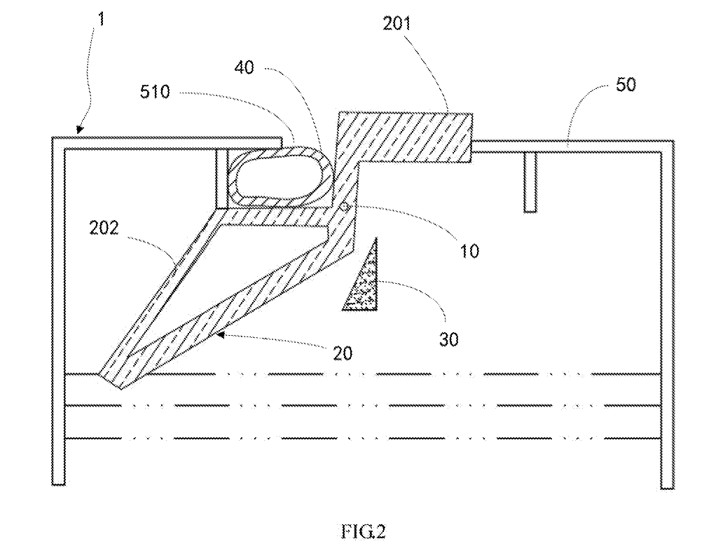

FIGS. 1 and 2 illustrate a waterproof valve in accordance with an embodiment.

The waterproof valve can be adopted in opening 510 of an electronic device 1, in order to prevent conductive fluids from flowing into electronic device 1. In at least one embodiment, the electronic device 1 includes a housing 50, the housing 50 defines a opening 510, the opening 510 can be an air vent or a sound aperture of the electronic device 1.

The waterproof valve can include a pivot 10 and a valve 20. In at least one embodiment, the pivot 10 can be a spindle, one end of the spindle is fixed on the inner surface of the housing 50, the valve is rotatably connected with the other end of the spindle.

One end of the valve 20 serves as a sealing end 201, the sealing end 201 located on one side of the spindle and used to seal the opening 510 in needs. The other end of the valve 20 serves as a floating end 202, the floating end 202 located on the other side of the spindle and used to detect fluids coming into the opening 510.

As shown in FIG. 1, when without fluids contacting the floating end 202, the sealing end 201 is released under its own gravity to keep the valve open, which means the sealing end 201 is separated with the opening 510, the electronic device 1 can work normally on this condition. A block bar 30 can be fixed on the housing 50 to limit the dock position of the floating end 202 when floating end 202 is without contact with fluids, to prevent the floating end 202 from swinging.

As shown in FIG. 2, when fluids come to the floating end 202, the floating end 202 rises under the effect of buoyancy, and the sealing end 201 is driven by the floating end 202 to seal the opening 510, so as to prevent fluids from coming into the housing 50 by the opening 510.

The floating end 202 can be hollow to increase the buoyancy, a hollow floating end 202 could be lighter and more sensitive to fluids.

The waterproof valve can further include a cushion 40, the cushion 40 can be fixed with the housing 50 and resist against the outer surface of the valve. When the valve is driven by the floating end 202, the cushion 40 is squeezed and deformed to retard the rotation of the valve.

The cushion can be a substantially “O” shaped ring made of elastic materials, such as foam or silicone.

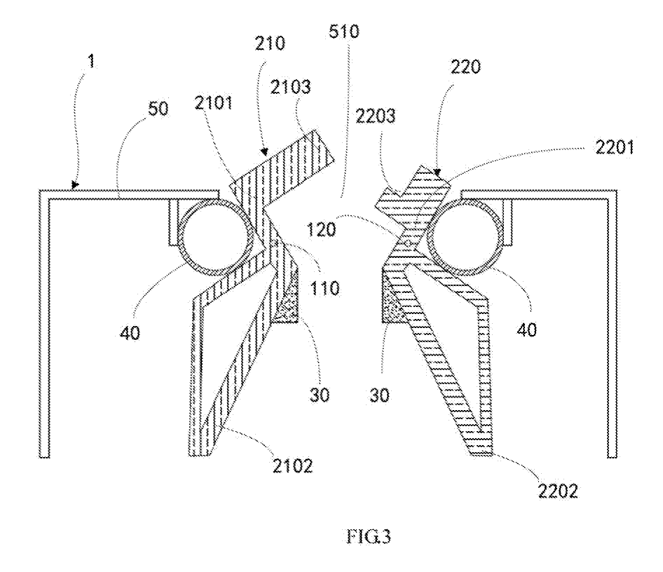

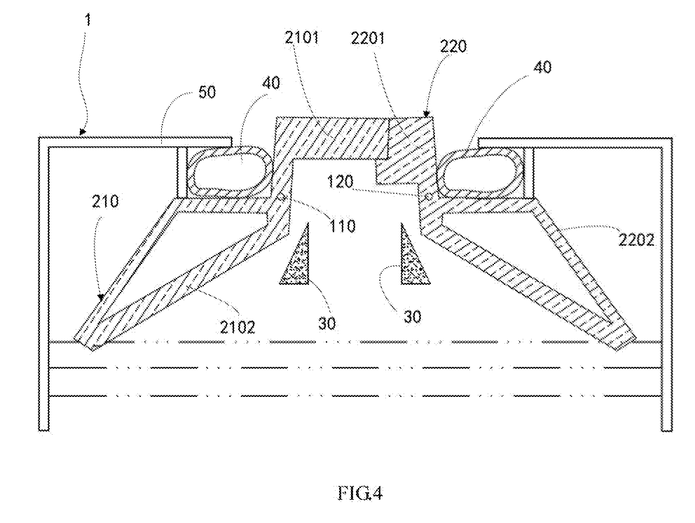

FIGS. 3 and 4 illustrate a waterproof valve in accordance with another embodiment.

As shown in FIGS. 3 and 4, the valve includes a first valve 210 and a second valve 220 symmetrically set to the first valve 210. The pivot 10 includes a first pivot 110 corresponding to the first valve 210 and a second pivot 120 corresponding to the second valve 220. The valve 210 and the second valve 220 are similar as the valve 20 shown in FIGS. 1 and 2. The first valve 210 includes a first sealing end 2101 and a first floating end 2102, the first pivot 110 is rotatably connected with the first valve 210 between the first sealing end 2101 and the second floating end 2102; the second valve 220 includes a second sealing end 2201 and a second floating end 2202.

As shown in FIG. 3, when the first floating end 2102 and the second floating end 2202 are without contact with fluids, the first sealing end 2101 and the second sealing end 2201 are separated with the opening 510, the electronic device 1 can work normally on this condition.

As shown in FIG. 4, When the first floating end 2102 and the second floating end 2202 are in contact with fluids, the first sealing end 2101 and the second sealing end 2201 are driven by the first floating end 2102 and the second floating end 2202 to close the opening 510 together, so as to prevent fluids from coming into the housing 50 by the opening 510.

Each of the first sealing end 2101 and the second sealing end 2201 can define a engagement portion. When the first sealing end 2101 and the second sealing end 2201 are driven by the first floating end 2102 and the second floating end 2202 to close the opening 510, the engagement portions reach an close contact with each other and seal the opening 510 together. The engagement portions can be a convex 2103 in the front end of the first sealing end 2101, and a groove in the front end of the second sealing end 2201.

The embodiments shown and described above are only examples. Many details are often found in the art such as the other features of a mounting system for hard disk drive. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A waterproof valve comprising:
a pivot;
a valve comprising a sealing end and a floating end, the pivot is rotatably connected with the valve between the sealing end and the floating end;
wherein the sealing end is released to keep the valve open when the floating end is not contact with fluids; the sealing end is driven by the floating end to close the valve when the floating end is contact with fluids.

2. The waterproof valve of claim 1, wherein the valve comprising a first valve and a second valve symmetrically set to the first valve, the pivot comprising a first pivot corresponding to the first valve and a second pivot corresponding to the second valve, the first valve comprising a first sealing end and a first floating end, the first pivot is rotatably connected with the first valve between the first sealing end and the first floating end; the second valve comprising a second sealing end and a second floating end, the first sealing end and the second sealing end are released to keep the valve open without contact with fluids; the first sealing end and the second sealing end are driven by the first floating end and the second floating end to close the valve together when contact with fluids.

3. The waterproof valve of claim 2, wherein each of the first sealing end and the second sealing end defines a engagement portion.

4. The waterproof valve of claim 1, wherein the waterproof valve comprising a block bar, the block bar is fixed on surrounding parts to limit the dock position of the floating end without contact with fluids.

5. The waterproof valve of claim 1, wherein the waterproof valve comprising a cushion, the cushion is fixed with surrounding parts and resist against the outer surface of the valve.

6. The waterproof valve of claim 5, wherein the cushion is made of elastic materials.

7. The waterproof valve of claim 6, wherein the elastic materials comprise foam and silicone.

8. The waterproof valve of claim 5, wherein the cushion is a substantially “O” shaped ring.

9. The waterproof valve of claim 1, wherein the floating end is hollow.

10. A electronic device comprising:
a housing comprising an opening;
a waterproof valve in the opening;
wherein the waterproof valve comprising:
a pivot;
a valve comprising a sealing end and a floating end, the pivot is rotatably connected with the valve between the sealing end and the floating end;
wherein the sealing end is released to keep the valve open when the floating end is not contact with fluids; the sealing end is driven by the floating end to close the valve when the floating end is contact with fluids.

11. The electronic device of claim 10, wherein the valve comprising a first valve and a second valve symmetrically set to the first valve, the pivot comprising a first pivot corresponding to the first valve and a second pivot corresponding to the second valve, the first valve comprising a first sealing end and a first floating end, the first pivot is rotatably connected with the first valve between the first sealing end and the first floating end; the second valve comprising a second sealing end and a second floating end, the first sealing end and the second sealing end are released to keep the valve open without contact with fluids; the first sealing end and the second sealing end are driven by the first floating end and the second floating end to close the valve together when contact with fluids.

12. The electronic device of claim 11, wherein each of the first sealing end and the second sealing end defines a engagement portion.

13. The electronic device of claim 10, wherein the waterproof valve comprising a block bar, the block bar is fixed on surrounding parts to limit the dock position of the floating end without contact with fluids.

14. The electronic device of claim 10, wherein the waterproof valve comprising a cushion, the cushion is fixed with surrounding parts and resist against the outer surface of the valve.

15. The electronic device of claim 14, wherein the cushion is made of elastic materials.

16. The electronic device of claim 15, wherein the elastic materials comprise foam and silicone..

17. The electronic device of claim 14, wherein the cushion is a substantially “O” shaped ring.

18. The electronic device of claim 10, wherein the floating end is hollow.
